(19) United States
(12) Patent Application Publication
(10) Pub. No.: US 2006/0233434 A1
(43) Pub. Date: Oct. 19, 2006

(54) Method and apparatus for inspection

(76) Inventors: Akira Hamamatsu, Yokohama (JP); Hisae Shibuya, Chigasaki (JP); Shunji Maeda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/402,100

(22) Filed: Apr. 12, 2006

(30) Foreign Application Priority Data
Apr. 15, 2005 (JP) 2005-117727

(51) Int. Cl. G06K 9/00

(52) U.S. Cl. 382/149

(57) ABSTRACT

This invention relating to an inspection apparatus capable of classifying defects at high accuracy makes it possible to accurately extract various characteristic quantities of each defect by using the images obtained by imaging a semiconductor wafer under dark-field illumination, and providing, with respect to a differential image signal between the image signals obtained from dies near to each other in image brightness, a defect detection threshold and a characteristic quantity extraction threshold lower than the defect detection threshold.

### BACKGROUND OF THE INVENTION

The present invention relates generally to inspection apparatuses and inspection methods used on manufacturing lines of semiconductor devices, liquid-crystal display devices, magnetic heads, or the like. More particularly, the invention relates to a technique for classifying detected defects.

Known conventional techniques concerned with apparatuses and methods for inspecting defects such as contamination includes the techniques proposed in Japanese Patent Laid-open Nos. 8-210989 (Conventional Technique 1) and 2000-105203 (corresponding to U.S. Pat. No. 6,411,377 B1) (Conventional Technique 2). The defect inspection apparatus that uses Conventional Technique 1 is outlined below. A laser beam that has been emitted from a semiconductor laser is split into a plurality of mutually incoherent beams, and then the surface of a substrate is irradiated with the beams effectively, simultaneously, and in converged form, at different angles of incidence. The incident light, after being scattered from micro foreign substance (particle) present on the substrate, is converged and defects on the substrate are detected using a detector. Also, the defect inspection apparatus that uses Conventional Technique 2 is outlined below. Linear, highly efficient illumination from a direction in which diffracted light from a pattern does not enter an objective lens is implemented, detection signal thresholds are set on the basis of the signal level dispersion that have been calculated for each region within a chip, and the apparatus is improved in detection sensitivity and in throughput.

Known methods of classifying the defects detected by these inspection apparatuses are described in Japanese Patent Laid-open Nos. 2004-47939 (corresponding to US 2004/0218806 A1) (Conventional Technique 3) and 2004-93252 (Conventional Technique 4). The defect classification apparatus that uses Conventional Technique 3 is described below. The determination of a hierarchical structure, and the specification of associated classification rules, for hierarchically categorizing defect-classifying classes according to a set of plural branch elements, are based on the display of the attribute distribution states of defective samples that have been user-taught for each branch element (the attribute distribution states include the degree of separation for each attribute, between the defective samples belonging to the defect-classifying classes). Next, Conventional Technique 4 is outlined below. The angle of illumination for irradiating an object to be inspected is optimized according to the particular state of the object. Next, foreign substances or defects are each detected at a plurality of pixel sizes in response to a signal obtained from detection optics provided to detect the light reflect-scattered from the object, the detection optics having its magnification optimized in advance. After the detection, the foreign substances or the defects are categorized according to the respective characteristic quantities.

Including such apparatuses as outlined in connection with the above conventional techniques, apparatuses for inspecting various fine-structured patterns in semiconductor devices and the like have had the problem in that during the processes where a transparent film such as an oxide film exists on a top layer, the interference of illumination due to the nonuniformity of the transparent film's thickness inside the wafer causes differences in the brightness of detected defects' images between dies to occur at nondefective sections.

Also, traditionally, defect detection thresholds for detecting defects with respect to the differential image signal between adjacent dies have been the same as thresholds for obtaining the defect image signals for extracting a primary characteristic quantity. In addition, the above two sets of thresholds have both been set to be high levels to prevent a false detection alarm from frequently occurring. These situations have caused another problem in that it is not possible to obtain effectively the characteristic quantities of defects that are extracted to classify the defects.

### SUMMARY OF THE INVENTION

The present invention relates to an inspection apparatus and inspection method adapted to allow defects to be classified with high accuracy.

The present invention provides an inspection apparatus including: a stage system which mounts a target substrate with a plurality of dies arrayed thereon and moves at least in an XY direction; illumination optical system for irradiating the substrate with illumination light; detection optical system for acquiring image signals by detecting reflected light obtained from the substrate; and an image processing unit for processing the image signals that have been acquired by the detection optical system. In the above apparatus, the image processing unit further includes a data storage into which are stored the image signals acquired by the detection optical system; a differential signal processing unit for obtaining a differential signal image by calculating differential between the images signals obtained for each die, in all the image signals stored within the data storage; a threshold setting unit for setting a first threshold and a second threshold higher than the first threshold; a comparison unit for comparing the differential image signal obtained from the differential signal processing unit, with each of the first threshold and second threshold set by the threshold setting unit; a characteristic quantity extraction unit for extracting various characteristic quantities of defects based on the defect image signals obtained from the comparison unit, and obtaining various characteristic quantity data of defects; and a defect classifying processing unit for classifying kind of defect in accordance with such characteristic quantity data of each defect as obtained from the characteristic quantity extraction unit, and with defect data obtained from the comparison unit.

The present invention also provides an inspection method including the steps of: irradiating onto a target substrate with illumination light while moving a stage in one direction on which the target substrate with a plurality of dies arrayed thereon is mounted; acquiring image signals by detecting reflected light obtained from the substrate during the irradiation with the illumination light; and processing the acquired image signals. In the above inspection method, the step of processing the image signals includes the sub-steps of: storing the acquired image signals; obtaining differential image signals by calculating differential between the images signals obtained for each die in the acquired image signals; setting a first threshold and a second threshold higher than the first threshold; comparing the differential image signal independently with each of the set first threshold and second threshold; and classifying kind of defect on the basis of defect signals obtained in the comparing step by conducting comparisons between the differential image signal and the first threshold and between the differential image signal and the second threshold.

According to the present invention, it is possible to realize an inspection apparatus adapted to allow defects to be classified with high accuracy.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing an embodiment of an inspection apparatus;

FIG. 2 is a functional block showing an example of a comparative image processor;

FIG. 3A shows the image of a 3×3-pixels region that was sampled from one of two dies;

FIG. 3B shows an image of a 3×3-pixels region with respect to a central pixel of A (i, j);

FIG. 3C shows the image of a 7×7-pixels region that was sampled from the other die, with a central pixel of B (i, j);

FIG. 3D shows an image of a 3×3-pixels region with respect to a central pixel of B′ (i, j) which was position-matched in pixel units to the central pixel of A (i, j) shown in FIG. 3B;

FIG. 4A shows the image of a 3×3-pixels region that was sampled from one of two dies;

FIG. 4B shows an image of a 3×3-pixels region with respect to a central pixel of A (i, j);

FIG. 4C shows the image of a 7×7-pixels region that was sampled from the other die, with a central pixel of B (i, j);

FIG. 4D shows an image of a 3×3-pixels region with respect to a central pixel of B′ (i, j) which was aligned in sub-pixel unit to the central pixel of A (i, j) shown in FIG. 4B;

FIG. 5 is a functional block diagram showing an example of a threshold setup unit;

FIG. 6 is a functional block diagram showing a first example of the image-processing unit shown in FIG. 1;

FIG. 7 is a functional block diagram showing a second example of the image-processing unit shown in FIG. 1;

FIG. 8 is a diagram showing the relationship between a defect detection threshold set for a differential signal (differential image signal) indicative of defects between dies close in brightness, and a threshold set to be lower than the defect detection threshold in order to extract a primary characteristic quantity;

FIG. 9 is a diagram explaining the various characteristic quantities of the defects obtained by the threshold set for extracting the primary characteristic quantity;

FIG. 10 is a diagram showing an example of process flow of defect classification conditions setup;

FIG. 11 is a diagram showing an example of process flow of inspection conditions setup;

FIG. 12 is a diagram that shows an example of displaying a defect distribution histogram which covers various characteristic quantities for each combination of defect species, and selecting desired characteristic quantities by use of an statistical distance index between defect groups (this indicates a separation degree between defect species) in order to set up defect classification conditions to be used to classify defects according to the kind of defect by repeating bifurcation under certain inspection conditions;

FIG. 13 is a diagram that shows an example of a defect sorting procedure to be used to sort defects according to the kind of defect by repeating bifurcation under certain inspection conditions;

FIG. 14 is a diagram that shows an example of a confusion matrix which indicates an accuracy ratio when the kind of defect is classified automatically under the defect classification condition;

FIG. 15 is a diagram that shows an example of defect inspection process flow;

FIG. 16 is a diagram that shows an example of semiconductor manufacturing processes which use inspection apparatuses; and

FIG. 17 is a diagram showing the relationship between the number of defects and production yield.

### DESCRIPTION OF THE PREFERRED EMBODIMENTS

Embodiments of an inspection method and inspection apparatus according to the present invention will be described below using the accompanying drawings.

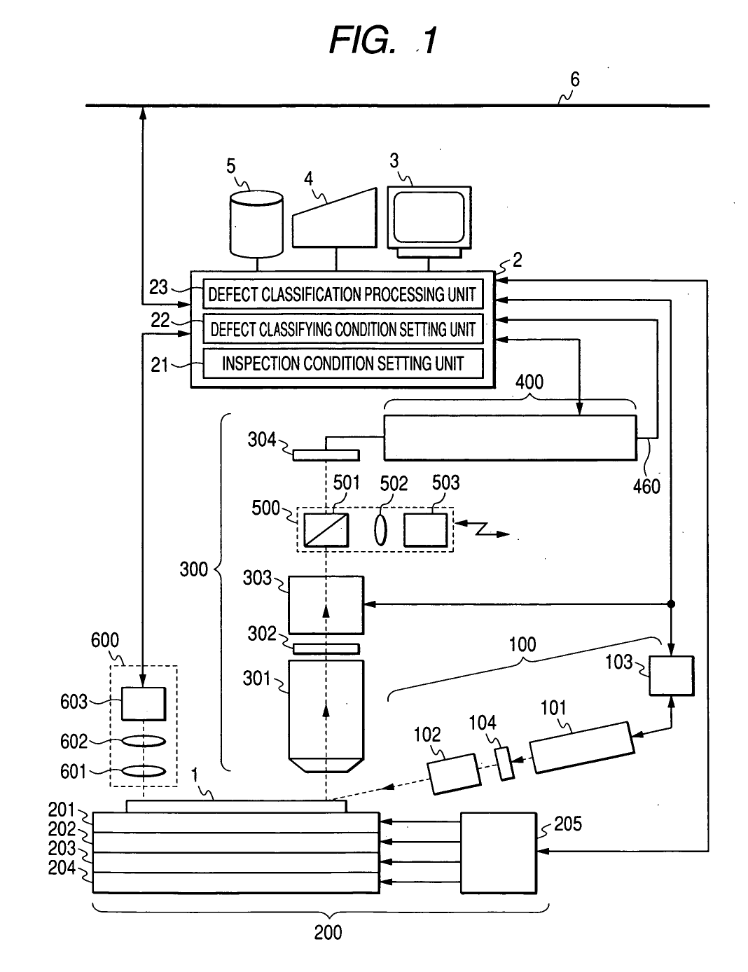

A block diagram of an embodiment of an inspection apparatus according to the present invention is shown in FIG. 1.

As described in Japanese Patent Laid-open Nos. 2000-105203 and 2004-93252, the above inspection apparatus includes: a total controller (CPU) 2 for controlling the entire apparatus; illumination optical system 100; a stage system 200 in which to mount a wafer 1 to be inspected; detection optical system 300 by which detection images (inspection images) of defects including foreign substances or the like, obtained from a substrate 1 such as the wafer, are acquired at different magnifications; an image-processor unit 400 which detects each of the defects by processing image signals acquired from an image sensor 304, and provides information of each defect to the total controller 2; Fourier transform plane viewing optical system 500 for viewing a Fourier transform plane on which a spatial filter 302 is installed; and wafer viewing optical system 600 for positioning (aligning) the substrate in a rotational direction and XY direction of the substrate by controlling the stage system based on viewing the substrate 1. The total controller (CPU) 2 sets up inspection conditions, defect classification conditions, and the like, executes defect classification processing, and controls the entire apparatus, including the illumination optical system 100, the detection optical system 300, stage system 200, image-processing unit 400, and other constituent elements of the apparatus. The total controller 2 with a connected display device 3, an input device 4, and a storage device 5, is connected to a CAD system, a reviewing apparatus, or the like, via a network 6.

The stage system 200 includes: a θ-stage (rotary stage) 201 for rotating the substrate 1, such as the wafer, on a horizontal surface; a Z-stage 202; an X-stage 203; a Y-stage 204; and a stage controller 205 for controlling the four stages.

The illumination optical system 100 includes: a light source 101 constituted, for example, as a laser light source; a neutral density (ND) filter 104 that automatically adjusts intensity of illumination light emitted from the light source 101, such as ultraviolet (UV) light or deep-ultraviolet (DUV) light; converging and irradiating optical system 102 that converges the illumination light in slit form on the substrate 1 from an oblique direction so as to allow dark-field illumination, for example, and irradiates the substrate with the converged light; and illumination optical system controller 103 that controls irradiation intensity by controlling the ND filter 104 and the like, and controls an illumination angle by selecting angles of a reflecting mirror. As described in JP Patent Laid-open No. 2004-93252, the converging and irradiating optical system 102 is adapted to allow any one of three kinds of illumination by selecting an angle of the reflecting mirror and other factors. The three kinds of illumination are: low-angle illumination (at angles from about 1 degree to 5 degrees) mainly for detecting foreign substance on the wafer surface; high-angle illumination (at angles from about 45 degrees to 55 degrees) mainly for detecting pattern defects and foreign substances of low height; and medium-angle illumination (at angles of about 20 degrees) for detecting essentially all forms of pattern defects and foreign substances.

When a laser light source is used as the light source, it is necessary, as described in Japanese Patent Laid-open No. 8-210989, that the converging and irradiating optical system 102 be constructed to split and change a beam emitted from the laser light source into a plurality of spatially incoherent beams by making mutually optical path lengths to differ and then irradiate the same section of the substrate 1 with slit beams at different angles of incidence in order to prevent interference.

The detection optical system 300 includes: an objective lens 301 for converging scattered light (diffracted light being not less than first-order) obtained from any defects including foreign substance on the substrate 1; the spatial filter 302 installed on the Fourier transform plane so as to intercept a diffracted light pattern (interference fringes) resulting from a repetition pattern formed on the substrate 1; a image-forming lens 303 being variable in magnification and constructed so that after the scattered light from the defects including foreign substances has been passed through the spatial filter 302, the lens 303 forms the scattered light into an image; and the image sensor 304, such as a CCD or a TDI (time-delayed integrator), that receives the scattered-light image formed by the image-forming lens 303 and converts the image into a signal. Use of the illumination optical system 100 is not limited to application as dark-field illumination optical system.

The Fourier transform plane observing optical system 500 includes an optical-path changing unit 501, a lens 502 for forming the image of the spatial filter 302, and a spatial filter observing camera 503 which, after the lens 502 has imaged the intercepted light pattern formed by the spatial filter 302, receives and observes the image. Also, at least the optical-path changing unit 501 configures to be taken in and out of the optical path of the detection optical system 300. The Fourier transform plane observing optical system 500 is therefore used to view through the spatial filter observing camera 503 the image of the intercepted light pattern, formed after the spatial filter 302 has intercepted the diffracted light pattern resulting from the repetition pattern formed by a memory cell or the like present on the substrate, and adjust the intercepted light pattern.

The wafer-observing optical system 600 includes a wafer-observing objective lens 601, illumination optical system (not shown) that illuminates the wafer through the wafer-observing objective lens 601, an image-forming lens 602 for observing the wafer, and a wafer-observing camera 603. An image obtained by imaging a reference mark, orientation flat, and other elements/portions of the wafer through the camera 603 of the wafer-observing optical system 600, therefore, is used for the total controller 2 to control the stages 201-204 via the stage controller 205 and hence to position the substrate 1 with respect to the illumination optical system 100 and the detection optical system 300. The wafer-observing optical system 600 can also detect any defects present on the substrate 1. Automatic focusing of the wafer with respect to the detection optical system 300 is not described herein.

Operation of the apparatus having the construction described above is as described below. That is to say, the substrate 1 mounted in the stage system 200 is irradiated with illumination light by the illumination optical system 100 from an oblique direction, for instance, and a detection image of defects including foreign substance, based on scattered light from the wafer 1, is acquired from the detection optical system 300. The detection image that has thus been acquired is processed by an image-signal processing unit 400 so that defects or defect candidates are detected, and these defects or defect candidates are further classified by kinds.

The inspection apparatus includes the total controller (CPU) 2, the display device 3, the input device 4, and the storage 5, and can conduct inspections with settings of arbitrary inspection conditions by using the screen of the display device 3. The apparatus can also save inspection results (position coordinates of defects, defect data inclusive of defect images, and characteristic quantities of the defects), the settings of the inspection conditions, and defect classification conditions, in the storage device 5.

Also, the inspection apparatus can be connected to the network 6, whereby inspection results, wafer layout information, lot numbers, inspection conditions, and other data can be shared on the network 6. In addition, the inspection apparatus includes the Fourier transform plane observing optical system 500, thus enabling easy setting of the spatial filter 302 which intercepts the diffracted light pattern resulting from the repetition pattern formed by the memory cell or the like. Furthermore, the apparatus has the wafer-observing optical system 600, which enables observation of, for example, detected defects and alignment marks.

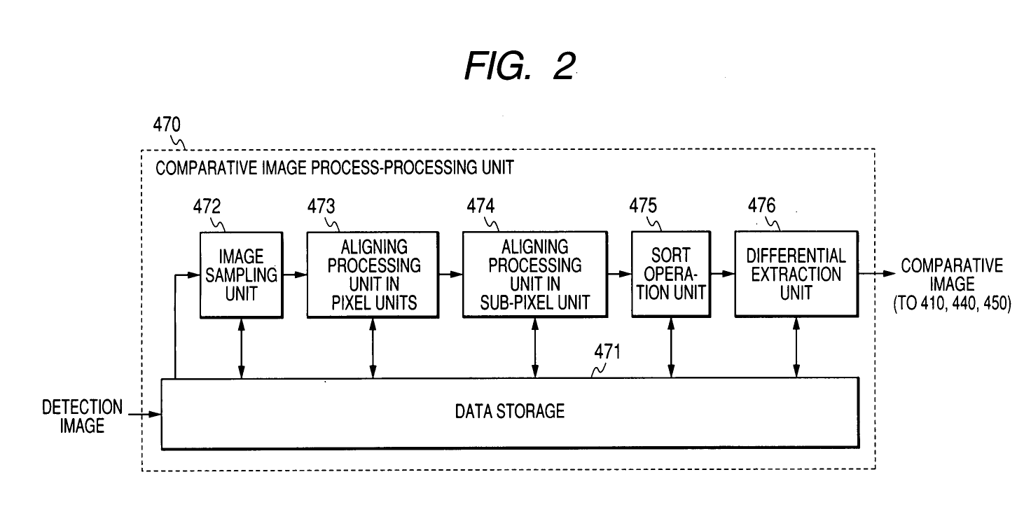

Next, a comparative image process-processing unit 470 in the image-processing unit 400 will be described using FIG. 2. For example, when the X-stage 203 is traveled, detection images of a rectangular region long in a Y-direction on the substrate 1, that is, a region whose width is equal to a longitudinal dimension of the image sensor 304 such as a time-delayed integrator (TDI), are output from the sensor 304. The detection images are then converted into digital image signals by an AD converter (not shown), and, for example, one line of rectangular region's detection image data in an X-direction on the above substrate is sequentially stored into a data storage 471. In this manner, detection image data associated with at least three dies constituting one line, for example, is stored into the data storage (image memory) 471. After this, an image sampling unit 472 samples (cuts out) each of the detection images between adjacent dies, at arbitrary image region sizes larger than one pixel (e.g., a 3×3 pixels region size and a 7×7 pixels region size).

Next at a pixel unit aligning processing unit 473, displacement amount of position in pixel unit between each of the detection images corresponding to each of the adjacent dies, is detected for each of the sampled arbitrary image regions (A (i−1, j−1) to A (i+1, j+1), B (i−3, j−3) to B (i+3, j+3)). After the detection, the detection image data between the adjacent dies are aligned in pixel unit and then stored into the data storage 471.

Next at a sub-pixel aligning processing unit, displacement amount of position (dx, dy) in sub-pixel unit between each of the detection images corresponding to each of the adjacent dies which have been mutually aligned in the pixel unit, is detected in sub-pixel unit for each of the sampled arbitrary image regions (A (i−1, j−1) to A (i+1, j+1), B (i−3, j−3) to B (i+3, j+3)). After the detection, the detection image data between the adjacent dies are aligned based on the displacement amount of position (dx, dy) in sub-pixel unit and then stored into the data storage 471.

Next at a sort operation unit 475, an average brightness value of the entire die or of a partial region in the die (i.e., the region of the highest defect detection sensitivity required: e.g., a logic region) is calculated for each of those detection images associated with the dies which were aligned with respect to one another in pixel units and in sub-pixel units. For example, each detection image associated with one line of die arrangement data (including an arrangement of at least three dies of data) is rearranged (sorted) in order of the calculated brightness, and the detection image data is stored into the data storage 471.

After this, a differential extraction unit 476 calculates a differential image signal between those detection images associated with the dies which were rearranged in order of the brightness, and supplies the differential image signal (differential image data) to a threshold setting unit 410, a first comparison unit 440, and a second comparison unit 450.

The pixel unit aligning processing unit 473 and sub-pixel position aligning processing unit 474 that aligning the detection images associated with the dies are not always necessary if the XY stage 203, 204 is high enough in accuracy. However, the detection images associated with the dies that are subjected to the calculation of the differential in the differential extraction unit 476 are the images that were rearranged in order of the brightness, and thus the dies are no longer adjacent ones. The pixel unit aligning processing unit 473 and sub-pixel aligning processing unit 474 that align the detection images associated with the dies, therefore, are most likely to become necessary.

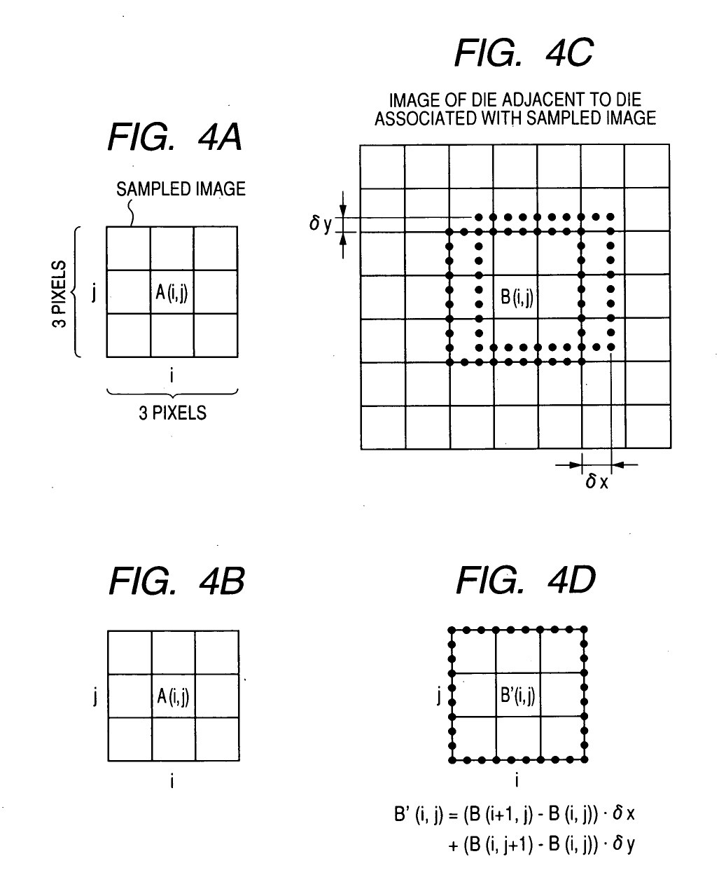

Sizes of the images during aligning, and sizes of the images during sorting do not always need to be equal to each other. In addition, since FIGS. 4A-4D only show examples of image processing, the images do not always require processing in accordance with the process flow described above. Furthermore, other processing may be added anywhere in the process flow. Moreover, these kinds of image processing are implemented with a processing substrate and/or general-purpose processor that uses a special LSI, FPGA, or the like.

As set forth above, since detection images associated with dies are sorted (rearranged) in order of brightness by the sort operation unit 475 using, for example, one line of detection image data stored within the data storage 471, the differential extraction unit 476 can take differential image data between the dies in which situations of irregularity of image brightness are near to each other. Dispersion in the differential image data can therefore be reduced at the partial region (e.g., logic region) for which the highest defect detection sensitivity within the dies is required.

Although storage capacity will be increased, the detection image data stored into the data storage 471 may be obtained from all dies present on the wafer 1. In this case, at the sort operation unit 475, detection image data from all dies on the wafer 1 will be rearranged in order of brightness.

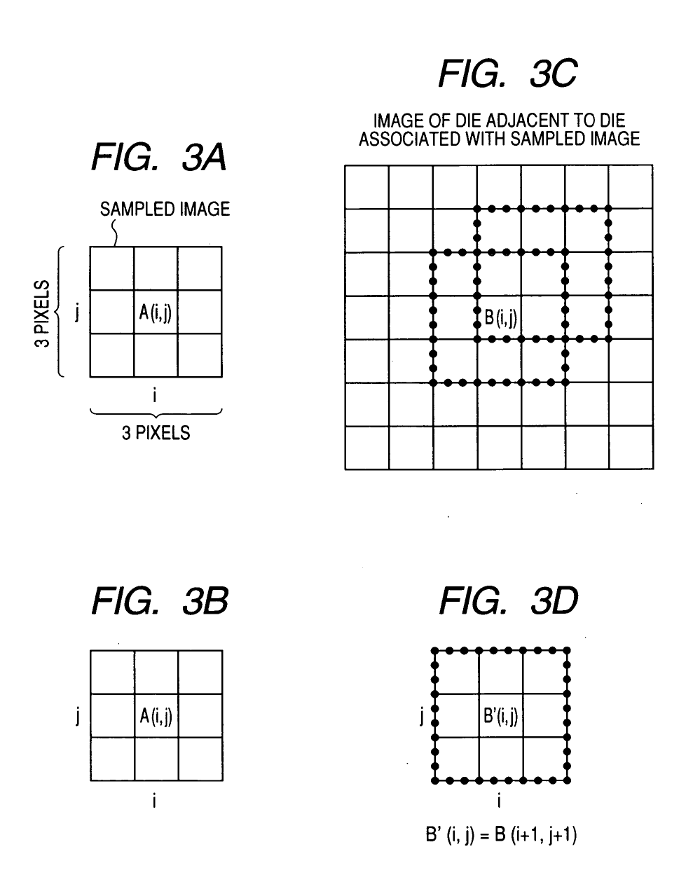

Next, an embodiment of the pixel unit aligning processing unit 473 will be described in detail using FIGS. 3A-3D. Aligning (position matching) between two adjacent dies is conducted as an embodiment of aligning in pixel units. While the present embodiment assumes a 3×3 pixels region, an image region in which aligning is to be conducted can be either larger or smaller than the 3×3 pixels region or can be non-square.

Suppose that signal intensity (grayscale value) of a central portion of the 3×3 pixels region that was sampled from one die shown in FIG. 3A is A (i, j), and that signal intensity (grayscale value) of a central portion of the 7×7 pixels region that was sampled from the other die shown in FIG. 3C is B (i, j). At that time, a sum of squares of difference of each pixel that corresponds between the dies in the 3×3 region is taken as an evaluation function F in accordance with formula (1) shown below. For example, when a size of a search region for aligning is ±1 pixel, a position of B (i, j) is shifted vertically and horizontally through one pixel.

A 3×3 region is selected for the new central pixel B′ (i, j) shown in FIG. 3D, and the above evaluation function F is calculated. A position at which F becomes a minimum is judged to be where the displacement amount in pixel unit between the dies is minimized, and the B′ (i, j) pixel at this time, shown in FIG. 3D, becomes a pixel-of-interest associated with the A (i, j) pixel shown in FIG. 3B (the pixel-of-interest is where the displacement amount in pixel unit between the dies is minimized). Displacement amount (position shifts) (in an X-direction, −2, −1, 0, +1, +2. and in a Y-direction, −2, −1, 0, +1, +2) in pixel unit at the pixel-of-interest are calculated. Therefore, A (i, j) and B (i, j) are aligned in pixel unit by shifting the position of a central pixel B (i, j) to a position of B′ (i, j) at the sampled image of the adjacent dies.

Although a vertical and horizontal search range of ±1 has been supposed for the 3×3 region in the present embodiment, the size of the region and the search range can be set arbitrarily. Incidentally, the search range of displacement amount has a close relationship with accuracy of the stage system 200 including the stage itself, and with a detection pixel size on the wafer. If the accuracy of the stage system 200 is taken as S (μm) (range) and the detection pixel size on the wafer as “d” [μm], the minimum search range required is expressed as ±((S÷d)+1) pixels, where S>d. A necessary and sufficient search range, therefore, needs to be set according to the accuracy of the stage system 200.
F=(A(i−1, j−1)−B′(i−1, j−1))²+(A(i−1, j)−B′(i−1, j))²+(A(i−1, j+1)−B′(i−1, j+1))²+(A(i, j−1)−B′(i, j−1))²+(A(i, j)−B′(i, j))²+(A(i, j+1)−B′(i, j+1))²+(A(i+1, j−1)−B′(i+1, j−1))²+(A(i+1), j)−B′(i+1, j))²+(A(i+1, j+1)−B′(i+1, j+1))² (1)

Next, an embodiment of the sub-pixel unit aligning processing unit 474 will be described in detail using FIGS. 4A-4D. The 3×3 pixels region shown in FIG. 4A is taken by way of example in description of an embodiment of aligning in sub-pixel unit similarly to aligning in pixel unit. In this example, as shown in FIG. 4C, a central pixel B(i, j) on an adjacent die is shifted through dx, dy, which are both equal to or smaller than the pixel size.

On the basis of a differential with respect to the image of the adjacent die, the resulting signal intensity of the B′ (i, j) portion shown in FIG. 4D is linearly interpolated using formula (2) below. Thus, the displacement amount of position (the positional shift) (dx, dy) in sub-pixel unit is calculated as the position where the evaluation function F calculated from above expression (1) becomes a minimum. The position of the central pixel B (i, j) in the sampled image of the adjacent die is consequently shifted through the above-calculated positional shift in sub-pixel unit, whereby the portion A (i, j) shown in FIG. 4B, and the portion B′ (i, j) shown in FIG. 4D are aligned in sub-pixel units. The size of a region and a search range can be arbitrarily set for above-described aligning in sub-pixel unit similarly to aligning in pixel unit.
B′(i, j)=((B(i+1)−B(i, j))·dx+(B(i, j+1)−B(i, j)·dy (2)

The calculation of the displacement amount in pixel unit and that of the displacement amount in sub-pixel unit are described in further detail in Japanese Patent Laid-open No. 10-318950.

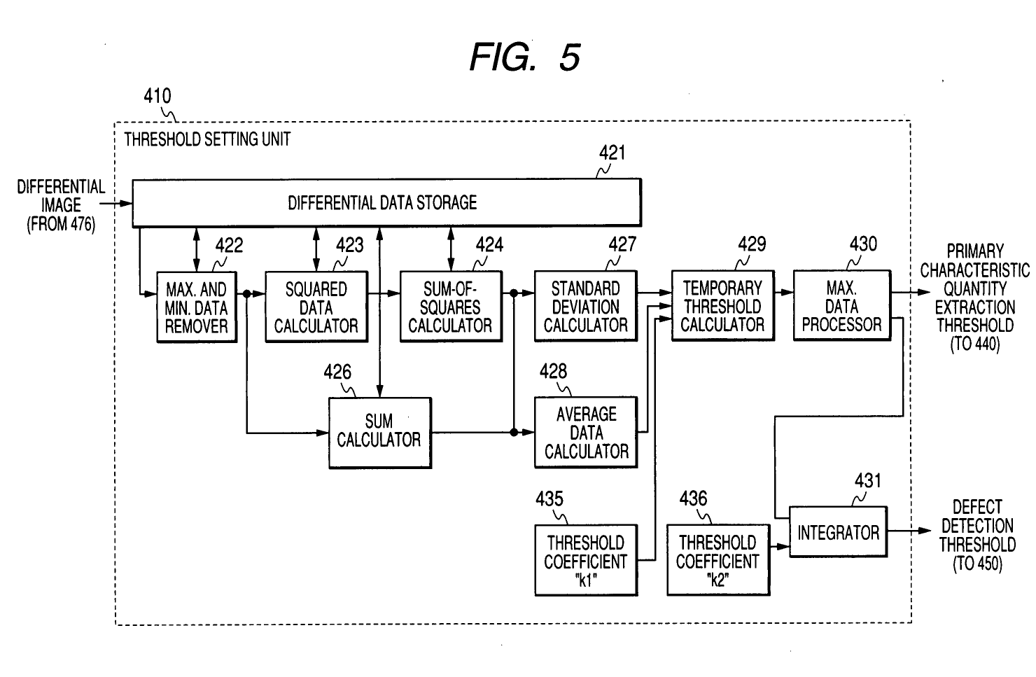

Next, an embodiment of the threshold setting unit 410 will be described using FIG. 5. After being obtained from the differential extraction unit 476 shown in FIG. 5, differential image data ΔS (i, j) between the dies closest to each other in image brightness is input as one line of die arrangement data (including an arrangement of at least three dies of data) or as all dies present on the wafer, and the data is stored into a differential data storage 421. The portion (i, j) denotes the pixel coordinates within the die, and “n” denotes the number of pixels compared between the dies closest to each other in image brightness.

First, maximum and minimum values indicative of an abnormality with respect to the above-stored differential image data ΔS(i, j) between the dies are removed from the image data by a maximum and minimum data remover 422. Next, squared values of pixel signals (grayscale levels) ΔS are calculated as ΔS² by a squared data calculator 423, and a sum of the squared values is calculated as SΔS² by a sum-of-squares calculator 424. Additionally, a sum of the pixel signals (grayscale levels) ΔS is calculated as SΔS by a sum calculator 426 with respect to the differential image data ΔS (i, j) from which the maximum and minimum values have been removed.

After that, based on the sum (SΔS) and the sum-of-squares (SΔS²), a standard deviation (d(d)=((SΔS²/n−SΔS/n))^{1/2}) and an average value (μ(d)=SΔS/n)) are calculated by a standard deviation calculator 427 and an average data calculator 428, respectively, by use of the number of pixels (“n”) contained in one line of die image data or in all dies of image data on the wafer. Next, a temporary threshold calculator 429 calculates temporary threshold data “Th1′” from the above-calculated average value (μ(d) (i, j)), standard deviation (d(d) (i, j)), and a previously set threshold coefficient “k1” (435). The threshold is determined by [Temporary threshold data (Th1′ (i, j))=Average value (μ(e) (i, j))±(Threshold coefficient “k1”×Standard deviation (d(e) (i, j))).

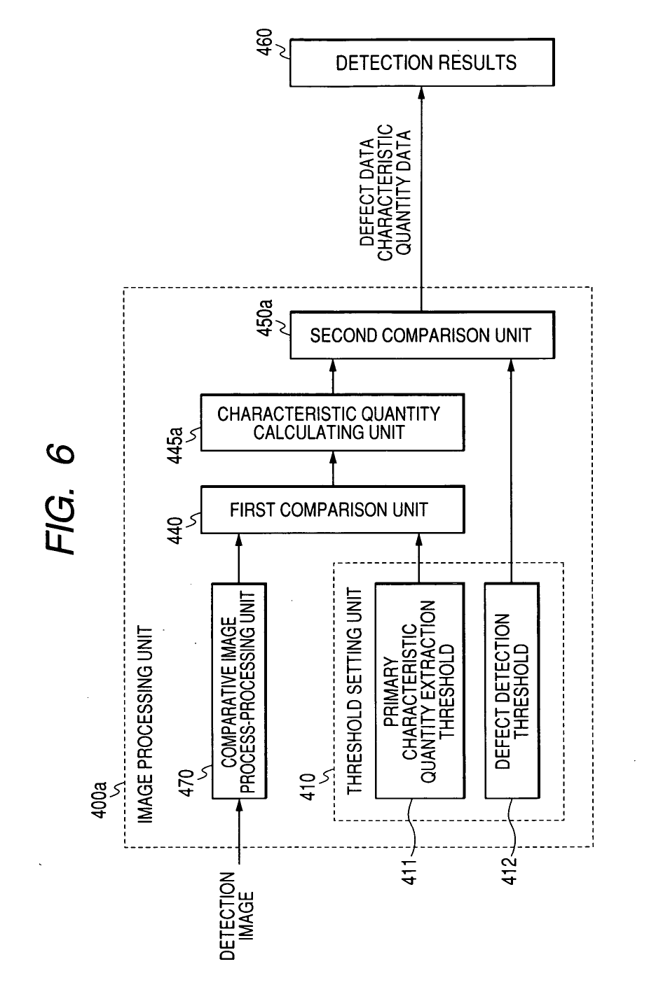

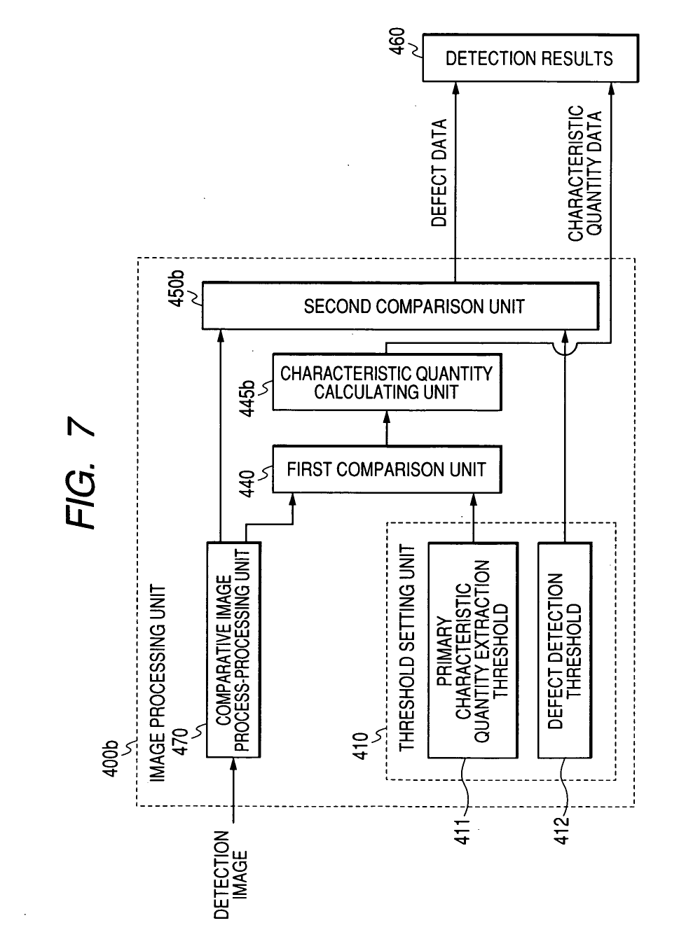

Next, the temporary threshold data (Th1′ (i, j)) that has been calculated by the temporary threshold calculator 429 is sampled from a 3×3 or 7×7 pixels group by a maximum data processor 430. After this, a maximum value of the sampled data is set as a primary characteristic quantity extraction threshold 411 for extracting a first threshold (Th1 (i, j)) present in a central pixel, and output to an integrator 431 as well as to the comparison unit 440 shown in FIGS. 6 and 7.

Furthermore, the integrator 431 obtains a second threshold (Th2 (i, j))=k2×(Th1 (i, j)) by integrating the first threshold (Th1 (i, j)) and a threshold coefficient “k2” greater than 1. The second threshold is then set as a defect detection threshold 412 and output to the comparison unit 450 shown in FIGS. 6 and 7. The second threshold (Th2 (i, j), a defect detection threshold, is set to a large value with margins to reduce false detection alarms. However, since the first threshold (Th1 (i, j)) is set to be lower than the second threshold (Th2 (i, j)), various characteristic quantities effective for classifying defects can be obtained.

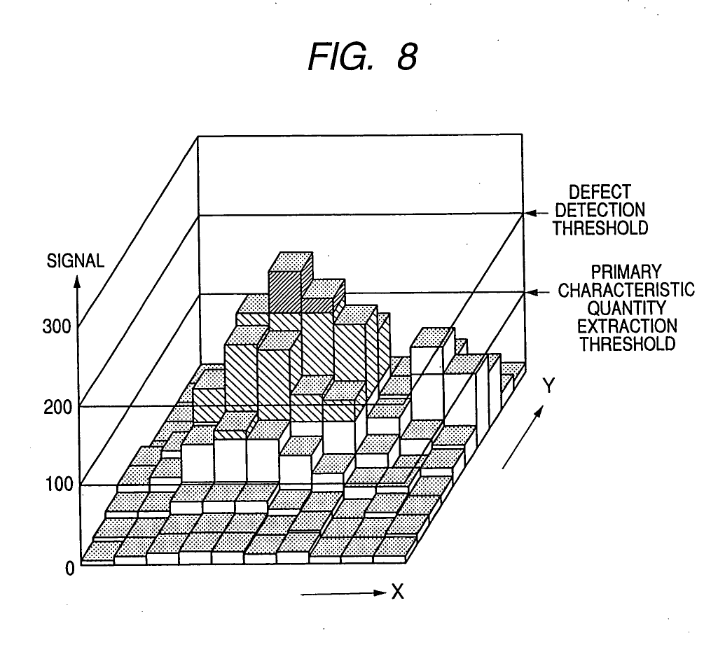

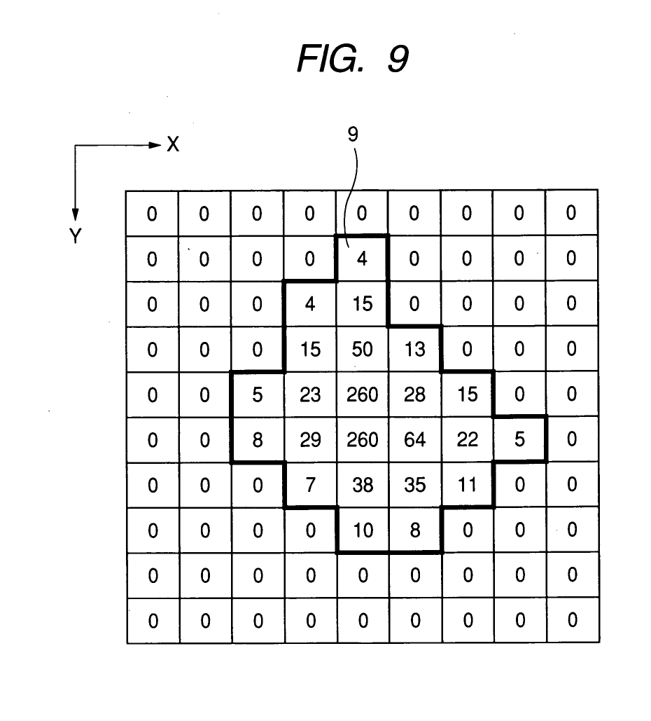

A feature of the present invention is as described below. The first threshold (Th1 (i, j)) for detecting differential signals (differential images) indicative of defects from which to extract characteristic quantities of the defects is set to a value smaller than that of the second threshold (Th2 (i, j)) to be used for detecting the defects from the differential signals (differential images) indicative thereof. Various characteristic quantities effective for classifying each defect, therefore, are extracted as shown in FIGS. 8 and 9, and consequently, it is possible to enhance a probability of classifying defects accurately on the basis of each various characteristic quantity or a spatial distribution (histogram, scatter diagram, or the like) of the characteristic quantities.

When defects are detected using the first threshold, defects that are not detectable using the second threshold will also be detected. It is possible, however, to exclude those defects by using position coordinates or IDs of the defects detected using the second threshold.

When the comparative image process-processing unit 470 uses a differential extraction function 476 thereof to calculate the differentials between detection images of the adjacent dies closest to each other in image brightness, mere aligning between the dies by the pixel unit aligning processing unit 473 and the sub-pixel unit aligning processing unit 474 does not make it possible to prevent ultra-micro displacement of position from occurring between the detection images of the adjacent dies closest to each other in image brightness, even if the XY stages 203, 204 are high enough in accuracy. Therefore, the maximum data processor 430 conducts sampling from the 3×3 or 7×7 pixels group and derives the maximum value therefrom. Thus, the ultra-micro displacement of position can be incorporated into the settings of the first and second thresholds. Of course, the maximum data processor 430 is not always necessary, provided that the XY stages 203, 204 are high enough in accuracy and that aligning between the adjacent dies suffices.

In addition, image-processing flow in the threshold setting unit 410 of FIG. 5 is just an example and images do not always require processing in accordance with this flow. Furthermore, other processing may be added anywhere in the flow.

Next, first and second embodiments of the image processing unit 400 will be described using FIGS. 6 and 7.

An image processing unit 400a of a first embodiment is shown in FIG. 6. In the present embodiment, the image processing unit 400a includes, in addition to the comparative image process-processing unit 470 shown in FIG. 2, a first comparison unit 440, a characteristic quantity calculating unit 445a, and a second comparison unit 450a.

In the first comparison unit 440, differential image signals obtained from the comparative image process-processing unit 470, between the dies in which situations of irregularity of image brightness are near to each other, are each compared with the first threshold (Th1 (i, j)) 411 set by the threshold setting unit 410, and any differential signals exceeding the first threshold (Th1 (i, j)) 411 are detected and are output as defect image signals.

The characteristic quantity calculating unit 445a calculates and outputs defect characteristic quantity data used for automatically classifying defect based on each of the defect's differential signals (differential image signals) output from the first comparison unit 440. The defect characteristic quantity data includes, for example, area, XY directional projection length, a maximum value or average value or integral volumetric value of grayscale value (brightness value) exceeding the respective thresholds. The characteristic quantity calculating unit 445a also outputs each defect differential signal (differential image signal) after receiving these signals from the first comparison unit 440.

The second comparison unit 450a detects a defect by comparing the differential signal thereof that is output from the characteristic quantity calculating unit 445a, with the second threshold (Th2 (i, j)) 412 set by the threshold setting unit 410. In addition to defect data such as position coordinates and differential signal of the defect, the second comparison unit 450a outputs, as detection results (inspection results) 460, the defect characteristic quantity data for automatically classifying defect, obtained from the characteristic quantity calculating unit 445a.

In the first comparison unit 440, although false detection alarms will occur because of the first threshold 411 being low, the false detection alarms can be excluded in the second comparison unit 450a by conducting checks against the position coordinates or IDs of the defects detected by the first comparison unit 440. The exclusion of the false detection alarms can, of course, be conducted in the total control unit 2 to which the detection results 460 are supplied.

An image processing unit 400b of a second embodiment is shown in FIG. 7. In the present embodiment, the image processing unit 400b includes, in addition to the comparative image process-processing unit 470 shown in FIG. 2, a first comparison unit 440, a characteristic quantity calculating unit 445b, and a second comparison unit 450b.

In the first comparison unit 440, differential signals obtained from the comparative image process-processing unit 470, between the dies in which situations of irregularity of image brightness are near to each other, are each compared with the first threshold (Th1 (i, j)) 411 set by the threshold setting unit 410, and any differential signals exceeding the first threshold (Th1 (i, j)) 411 are output as defect image signals.

The characteristic quantity calculating unit 445b calculates defect characteristic quantities from each defect differential signal (differential image signal) output from the first comparison unit 440, and outputs the defect characteristic quantity data used for automatic defect classifying, as detection results (inspection results) 460.

The second comparison unit 450b detects a defect by comparing the differential signal obtained from the comparative image process-processing unit 470, between the dies in which situations of irregularity of image brightness are near to each other, and the second threshold (Th2 (i, j)) 412 set by the threshold setter 410, and outputs position coordinates of the defect, differential signal thereof, and other defect data, as detection results (inspection results) 460.

In the first comparator 440, although false detection alarms will occur because of the first threshold 411 being low, the false detection alarms can be excluded in the second comparator 450b by conducting checks against the position coordinates or IDs of the defects detected by the first comparator 440. The exclusion of the false detection alarms can, of course, be conducted in the total control unit 2 to which the detection results 460 are supplied.

As described above, not only the position coordinates of the defect which has been detected using the defect detection threshold (Th2 (i, j)) 412 with respect to the differential signal (differential image signal) between the dies closest to each other in the uniformity level of image brightness, but also the differential signal and other defect data of the particular defect are, as shown in FIG. 8, supplied from the image-processing unit 400a, 400b, to the total control unit 2 of FIG. 8, as detection results (inspection results) 640. Additionally, various characteristic quantity data that has been calculated as the data effective for sorting, for the defect detected using the primary characteristic quantity threshold (Th1 (i, j)) 411 lower than the defect detection threshold (Th2 (i, j)) 412 with respect to the above differential signal, is supplied from the image-processing unit to the total control unit 2 as detection results (inspection results) 640. If inspection conditions are modified prior to supply of the above three sets of data as the detection results (inspection results) 640, various characteristic quantity data effective for sorting will, of course, be recalculated for the defects detected under the new inspection conditions, and the data will be supplied.

FIG. 9 shows grayscale levels (brightness levels) of a defect 9 which was detected by using the primary characteristic quantity threshold (Th1 (i, j)) 411. Various characteristic quantity data is calculated from the grayscale levels of the defect 9. The characteristic quantity data includes, for example, an area (23) that is expressed in the number of pixels, X- and Y-axial projection lengths (6, 7) that are expressed in the number of pixels in X- and Y-directions, and a maximum value (260), average value (40.4), or integral value (929) of the grayscale levels.

Next, setting of inspection conditions and defect classification conditions for classifying defects, in the total control unit (CPU) 2, will be described below.

First, as shown in FIG. 1, the total control unit 2 includes: an inspection condition setting unit 21 that sets an irradiation angle and irradiation luminous quantity of illumination optical system 100, the threshold coefficient “k1” determining the first threshold (Th1 (i, j)) 411, and other inspection conditions associated with defect classifying; a defect classifying condition setting unit 22 that sets the defect classifying conditions; and a defect classification processing unit 23 that classifies defects in accordance with the above inspection conditions set by the inspection condition setting unit 21, with the defect classifying conditions set by the defect classifying condition setting unit 22, and with the detection results (inspection results) 460.

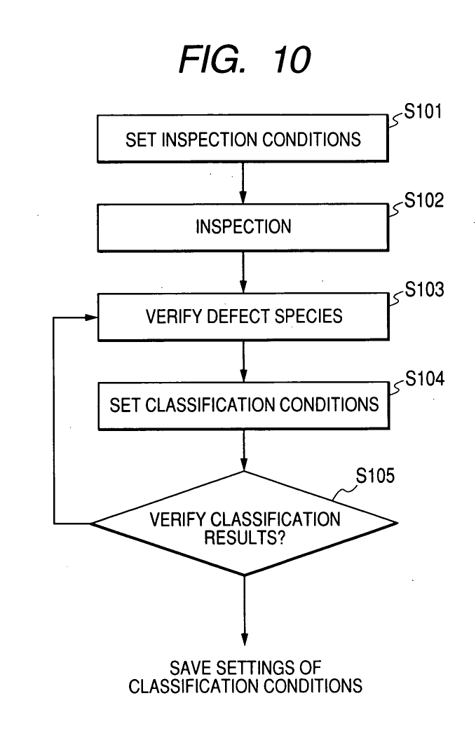

As shown in FIG. 10, the inspection conditions setting unit 21 executes: inspection conditions setting (step S101); inspection (step S102); defect species verification (step S103) for verifying (confirming) the kinds of defects inspected in the inspection step; classification conditions setting (step S104) for setting the conditions for classifying defects into the kinds thereof verified in the defect species confirmation step; and classification result verification (step S105) for verifying (confirming) the classification results classified under the classification conditions according to the particular kind set in the classification conditions setting step (S104), to determine final classification conditions, and saving the final classification conditions in a storage device 5.

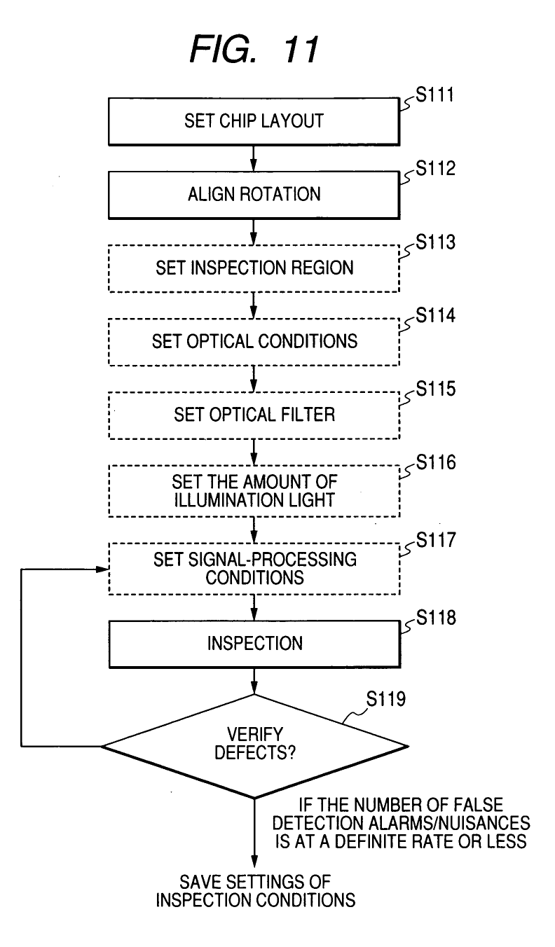

Inspection conditions setting (S101) is a process step of setting such inspection conditions as shown in FIG. 11, on a monitor screen of a display device 3, in the total control unit 2 (inspection condition setting unit 21), and storing the inspection conditions into the storage device 5.

As shown in FIG. 11, inspection conditions (inspection recipe) setting performed by the inspection condition setting unit 21 of the total control unit 2 before the inspection is executed further includes: chip layout setting (S111) for matching to a substrate 1 to be inspected; rotational aligning (S112) of the substrate; inspection region setting (S113); optical conditions setting (S114); optical filter setting (S115); irradiation luminous quantity setting (S116); signal-processing conditions setting (S117); inspection (S118); and defect verification (S119).

Chip layout setting (S111) is conducted by the inspection conditions setting unit 21 to specify a die size and whether dies are present on the wafer, to the image processing unit 400 and the like by using CAD information and others. The die size needs to be set, since it is associated with the distance data used for conducting comparisons.

Rotational aligning (S112) is conducted to render a layout direction of the dies on the stage-mounted wafer and a pixel direction of image sensor 304 parallel to each other under control of stage system 200 by the inspection conditions setting unit 21, based on wafer observation results observed by wafer-observing optical system 600. Since repeated dies on the wafer are arranged in direction of one axis by rotational aligning, comparison processing between the dies can be easily conducted.

Inspection region setting (S113) is executed to set inspection locations on the wafer and set a detection sensitivity (first and second thresholds) in inspection regions which include a memory region within a specific die, a logic region, and the like. Both the inspection location setting and the detection sensitivity setting are controlled by the inspection conditions setting unit 21 with respect to the image processing unit 400 by use of CAD information, a threshold data map, and the like.

Optical conditions setting (S114) refers to selecting a direction of illumination light irradiating onto wafer in a horizontal plane, an angle of inclination of the illumination light with respect to the horizontal plane (i.e., a low angle, a medium angle, or a high angle), and in some cases, a magnification of detection optical system 300. These conditions (parameters) are controlled by the inspection conditions setting unit 21 with respect to illumination optical system 100 and the detection optical system 300. Optical filter setting (S115) is conducted to set the spatial filter 302 and others controlled by the inspection conditions setting unit 21 with respect to the detection optical system 300.

Irradiation luminous quantity setting (S116) is conducted by the inspection conditions setting unit 21 to set irradiation luminous quantities (irradiation intensity) by controlling, for example, an ND filter 104 of the illumination optical system 100. Signal-processing conditions setting (S117) is conducted to set threshold coefficients “k1”, “k2”, etc. concerned with the first and second thresholds (Th1 (i, j), (Th2 (i, j)) used to detect defects according to a particular inspection region set in the die during inspection region setting. Inspection (S118) is a step of conducting inspections under the inspection conditions set in steps S111 to S117. During defect verification (S119), if the number of false detection alarms or nuisances is at a definite rate or less, the signal-processing conditions that were set in step S117 independently for each set of optical conditions in step S114 and for each set of irradiation luminous quantities in step S116 are determined and then saved in the storage device 5.

Next during the inspection (S102), the total control unit 2 controls the threshold coefficient “k1” with respect to the image processing unit 400, the irradiation angle and irradiation luminous quantity with respect to an illumination optical system controller 103, and a stage controller 205, in accordance with the inspection conditions stored into the storage device 5 during inspection conditions setting (S101). After the above, the substrate 1 is inspected under the controlled inspection conditions by the inspection apparatus. Detection results (inspection results) 460 with assigned defect IDs are input to the total control unit 2 and then stored into the storage device 5.

Next during defect species verification (S103), the total control unit 2 displays, on the monitor screen of the display device 3, defect-identifying differential images of the defect IDs which have been stored as detection results 460 into the storage device 5 during the above inspection (S102). Thus, the kinds of defects (e.g., large foreign substance, small foreign substance, pattern defect, scratch, film bottom defect, or others) are verified on the monitor screen, then each assigned to an appropriate defect ID using an input element or method 4, and stored into the storage device 5. The kinds of defects in the defect species verification step (S103) can be those which have been verified in a reviewing apparatus (not shown) with respect to the defect IDs, and the verified kinds of defects are input via a network 6 and stored into the storage device 5.

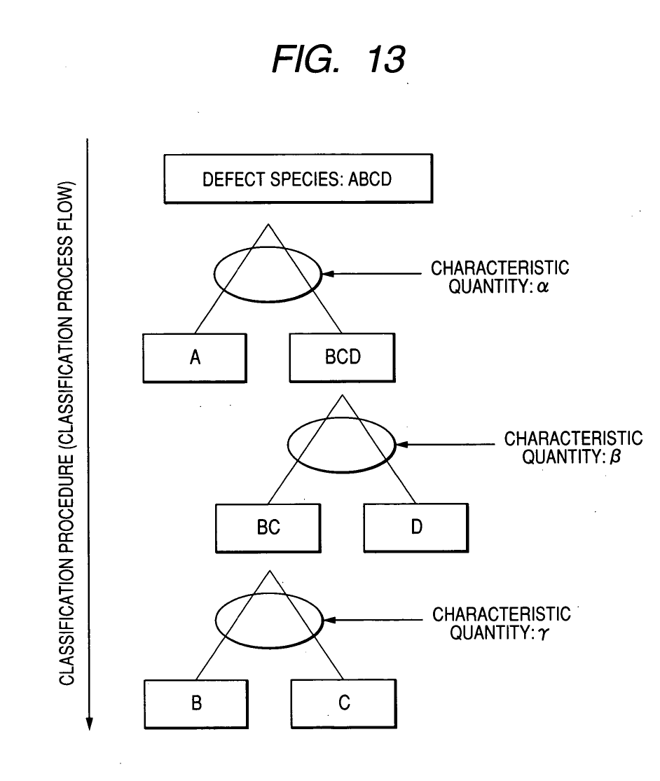

Next during classification conditions setting (S104), the total control unit 2 (defect classifying condition setting unit 22) calculates statistical distance indices by using plural combinations of multi-dimensional characteristic quantity spaces (e.g., scatter diagrams) or two- to three-dimensional characteristic quantity spaces (e.g., scatter diagrams). These combinations of characteristic quantity spaces are each based on various characteristic quantities obtained, even under different inspection conditions concerned with defect classification, for a combination of the defect specifies which were verified in defect species verification step S103 (e.g., as shown in FIG. 13, from top in order, a combination of three of four characters, A, B, C, D, a combination of three characters, and a combination of two characters). The characteristic quantities here refer to a (e.g., low-angle illumination, a large quantity of irradiation light, and an area as a characteristic quantity), B (e.g., high-angle illumination, a medium quantity of irradiation light, and XY projection length as a characteristic quantity), and y (medium-angle illumination, a medium quantity of irradiation light, and a maximum grayscale (brightness) value as a characteristic quantity).

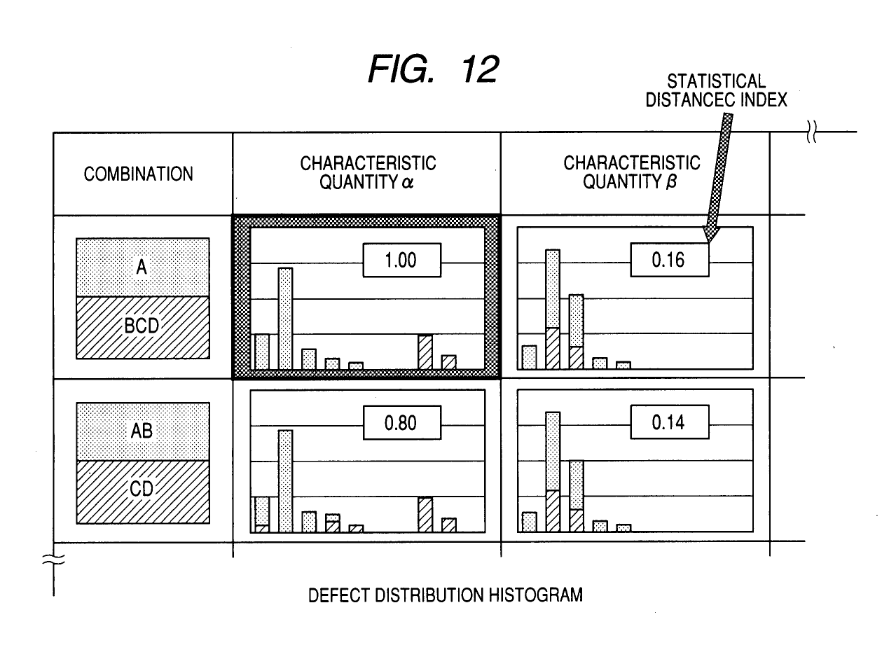

Based on such calculation results, varied defect distribution histograms each with various characteristic quantities taken on a horizontal axis, as shown in FIG. 12, for example, are created for the combinations of defect species. These varied defect distribution histograms for the combinations of defect species are then displayed with respective statistical distance indices on the monitor screen of the display device 3.

Of all characteristic quantities displayed horizontally on the monitor screen to automatically bifurcate the kinds of defects, only the characteristic quantity associated with the highest (largest) statistical distance index is selected either automatically or manually using the input element or method 4. The thus-selected characteristic quantity is stored as one defect classification condition into the storage device 5 and set in the total control unit 2.

That is to say, with respect to all combinations of defect species, the defect classifying condition setting unit 22 calculates the statistical distance index indicating a separation degree between different defect species, for each characteristic quantity, and selects the characteristic quantities and defect species combinations for which the statistical distance index indicating a separation degree becomes a maximum. Conditions for separating (bifurcating) the defect species into two groups are set in this manner.

Repeating this bifurcation will set the classification condition of classifying the defect into various kinds. The above statistical distance indices can be obtained by calculating separation degrees (separation levels) between different defect species using plural combinations of multi-dimensional characteristic quantity spaces or two- to three-dimensional characteristic quantity spaces. For example, an Euclidean distance, Maharanobis distance, entropy, or the like between the defect groups may be used as each such separation degree. In addition, a user can display desired characteristic quantities and combinations of defect species selectively on the monitor screen of the display device 3 during defect classification conditions setting.

Furthermore, as shown in a classification flowchart of FIG. 13, the characteristic quantity a of the highest statistical distance index as a classification condition for bifurcating defects into defect species A and BCD is set first. The characteristic quantity B of the highest statistical distance index as a classification condition for bifurcating defects into defect species BC and D is next set. After this, the characteristic quantity y of the highest statistical distance index as a classification condition for bifurcating defects into defect species B and C is further set.

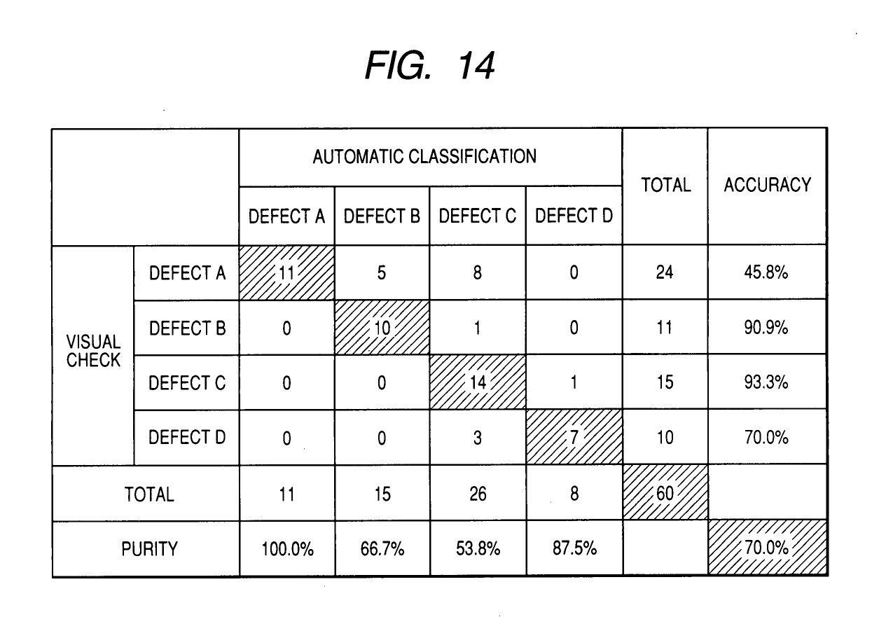

Next, the classification result verification step (S105) is conducted by the defect classifying condition setting unit 22 to verify a confusion matrix of FIG. 14, for example, by displaying this matrix on the monitor screen of the display device 3 as the results of classifying under the classification conditions which were set in the classification conditions setting step (S104). A classification accuracy ratio is thus displayed during or after setting of the classification conditions, so the classification results can be immediately verified. Visual check (verification) is results obtained by verifying the kind of defect spices in the above-mentioned defect species verification step (S103) and storing into the storage device 5.

Automatic classification results are obtained by extracting from data of the defect distribution histograms that were created by setting the classification conditions for repeating the bifurcation in the classification conditions setting step (S104). In other words, automatic classification provides the same classification results as those derived from classifying in the defect classification processing unit 23 under the defect classification conditions set by the defect classifying condition setting unit 22. As described above, the classification conditions stored within the storage device 5 are established as final ones when those sorting conditions do not need to be modified on the result of verifying the classification results.

Thus, the inspection conditions and the defect-classification conditions are established and stored in the storage device 5.

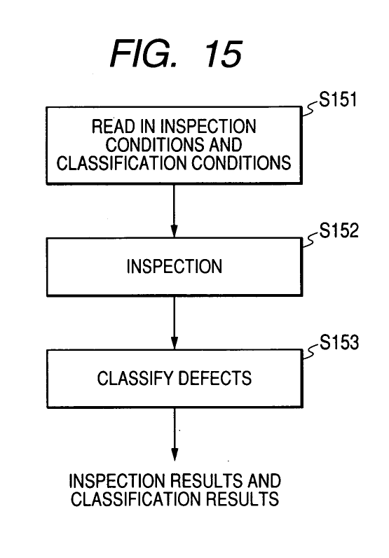

Next, a normal inspection sequence and a defect classification sequence in the total control unit 2 (defect classification processing unit 23) are described below using FIG. 15. In step S151, the total control unit 2 (defect classification processing unit 23) reads in pluralities of inspection conditions (at least with modified settings of the irradiation angle and the irradiation luminous quantity) and of classification conditions, from the storage device 5. After that, in step S152, the total control unit 2 (defect classification processing unit 23) conducts independent inspections under each set of above-read plural inspection conditions, acquires detection results 460 associated therewith, and stores the detection results into the storage device 5. Next in step S153, on the basis of the detection results 460 acquired for each set of inspection conditions, the total control unit 2 (defect classification processing unit 23) automatically classifies defects by repeating the bifurcation thereof in accordance with the classification procedure of FIG. 13 that defines the above-read classification conditions, and outputs inspection results and classification results. Accuracy ratios of the defect classification obtained at this time are as listed in FIG. 14.

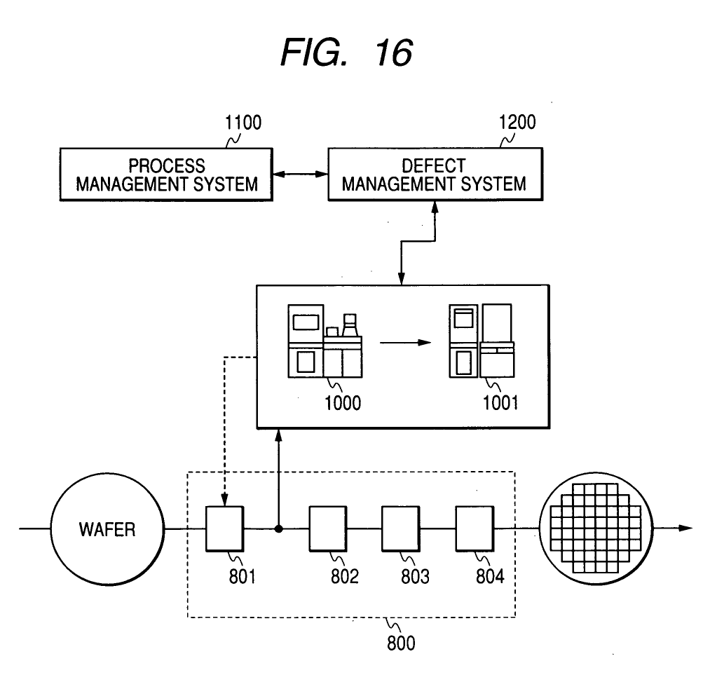

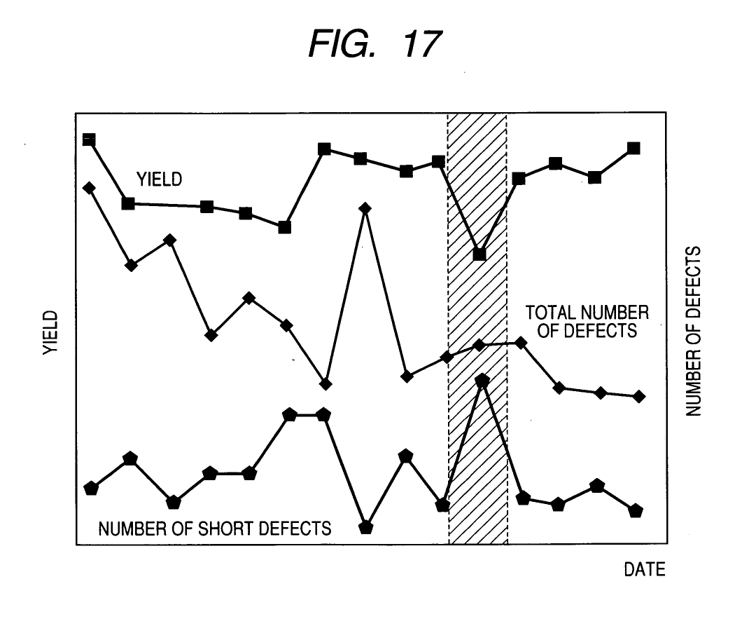

Next, the relationship between inspection apparatus 1000 of the present invention and a semiconductor-manufacturing apparatus group 800 (manufacturing processes 801 to 804: photo process 801, etching process 802, deposition process 803, and CMP process 804) is described below using FIGS. 16 and 17. A wafer 1 that has passed through a specific process 801 is inspected by the inspection apparatus 1000 of the present invention. Of course, it is possible, even with the inspection apparatus 1000, to execute classification based on various characteristic quantities as described above, and supply classification results to a defect management system 1200. Additionally, by tracing back details of defects with a reviewing apparatus 1001 or the like, the defect management system 1200 can feed back to each manufacturing process site being each generation cause of the defects via a process management system 1100. Repeating this procedure makes it possible to improve semiconductor devices in yield and thus to manufacture highly reliable semiconductor devices.

FIG. 17 shows the relationship between the number of defects and the yield of semiconductor products. During a hatched time period, although there is a significant decrease in the yield, there is only a slight increase in a total number of defects. Classifying detected defects and focusing attention on the number of SHORT defects allows one to see that in the time period during which there is a decrease in the yield, there is also a decrease in the number of SHORT defects. In the inspection apparatus 1000 of the present invention, therefore, information that has a correlation with the yield of semiconductor products can be obtained by monitoring not only the total number of defects, but also the number of classified defects of each kind, and supplying both the total number of defects and the above-monitored information to the defect management system 1200.

The invention may be embodied in other specific forms without departing from the spirit or essential characteristics thereof. The present embodiment is therefore to be considered in all respects as illustrative and not restrictive, the scope of the invention being indicated by the appended claims, rather than by the foregoing description, and all changes that come within the meaning and range of equivalency of the claims are therefore intended to be embraced therein.

1. An inspection apparatus comprising:
a stage system which mounts a target substrate with a plurality of dies arrayed thereon and moves at least in an XY direction;
an illumination optical system which irradiates the substrate with illumination light;
a detection optical system which acquires image signals by detecting reflected light obtained from the substrate; and
an image processing unit which processes the image signals that have been acquired by the detection optical system;
wherein the image processing unit further includes:
a data storage adapted to store therein the image signals acquired by the detection optical system;
a differential signal processing unit which obtains differential image signals by calculating differential between image signals obtained for each die in the image signals stored within the data storage;
a threshold setting unit which sets a first threshold and a second threshold higher than the first threshold;
a comparison unit which compares the differential image signals obtained from the differential signal processing unit, with each of the first threshold and second threshold set by the threshold setting unit so as to obtain defect image signals and defect data;
a characteristic quantity extraction unit which extracts various characteristic quantities of defects based on the defect image signals obtained from the comparison unit, so as to obtain various characteristic quantity data of defects; and
a defect classifying processing unit which classifies kind of defects, based on the various characteristic quantity data of defects obtained from the characteristic quantity extraction unit and the defect data obtained from the comparison unit.

2. The inspection apparatus according to claim 1, wherein the image processing unit further includes a aligning processing unit which conducts aligning in pixel unit or sub-pixel unit (smaller than the pixel unit) between image signals obtained from each of adjacent dies in the image signals stored within the data storage so as to store the aligning image signals.

3. The inspection apparatus according to claim 1, wherein the threshold setting unit sets the first and second thresholds based on the differential image signals obtained from the differential signal processing unit.

4. The inspection apparatus according to claim 1, wherein the defect classifying processing unit classifies the kind of defects by repeating bifurcation based on the various characteristic quantity.

5. The inspection apparatus according to claim 1, wherein:
the image processing unit further includes a defect classifying condition setting unit which sets defect classification conditions beforehand; and
the defect classifying processing unit classifies the kind of defects in accordance with the defect classification conditions set by the defect classifying condition setting unit based on the various characteristic quantity data of defects and the defect data.

6. The inspection apparatus according to claim 5, wherein:
the defect classifying condition setting unit sets a characteristic quantity of defect obtained from the characteristic quantity extraction unit as the defect classification condition, the characteristic quantity of defect having a largest separation degree between bifurcated defect species for each bifurcation to classify the kind of detect by repeating the bifurcation, the characteristic quantity further including characteristic quantity of defect, obtained when at least an irradiation angle and irradiation luminous quantity of the illumination optical system are modified as inspection conditions.

7. The inspection apparatus according to claim 5, wherein the defect classifying conditions setting unit displays on a screen of a display device an accuracy ratio of defect when the kind of defect is classified in accordance with the set defect classification conditions in the defect classifying processing unit.

8. An inspection apparatus comprising:
a stage system which mounts a target substrate with a plurality of dies arrayed thereon and moves at least in an XY direction;
an inspection conditions setting unit which sets a plurality of inspection conditions for controlling an irradiation angle and irradiation luminous quantity of illumination light onto the target substrate;
an illumination optical system which irradiates the substrate with the illumination light under various inspection conditions set by the inspection conditions setting unit;
a detection optical system which acquires image signals by detecting reflected light obtained from the substrate; and
an image processing unit which processes the image signals that have been acquired by the detection optical system;
wherein the image processing unit further includes:
a data storage adapted to store therein the image signals acquired by the detection optical system for each of the inspection conditions;
a comparative image process-processing unit including:
a sort operation unit which the image signals stored within the data storage for each of the inspection conditions, rearranges the image signals obtained for each die, in order of brightness; and
a differential signal processing unit which obtains a differential signal image for each of the inspection conditions by calculating differential between image signals of dies in which image brightness are near to each other, in image signals for each of dies rearranged for each of the inspection conditions by the sort operation unit;
a threshold setting unit which sets for each of the inspection conditions a second threshold and a first threshold lower than the second threshold;
a first comparison unit which compares the differential image signal obtained from the differential signal processing unit for each of the inspection conditions, with the first threshold set by the threshold setting unit for each of the inspection conditions, so as to obtain, for each of the inspection conditions, defect image signals exceeding the first threshold;
a characteristic quantity extraction unit which extracts various characteristic quantities of defects based on the defect image signals obtained from the first comparison unit for each of the inspection conditions, so as to obtain various characteristic quantity data of defects;
a second comparison unit which obtains defect data by comparing the differential image signal obtained from the differential signal processing unit for each of the inspection conditions, with the second threshold set by the threshold setting unit for each of the inspection conditions, so as to detect, for each of the inspection conditions, defects exceeding the second threshold; and
a defect classifying processing unit which classifies kind of defects, based on the various characteristic quantity data of defects obtained for each of the inspection conditions from the characteristic quantity extraction unit and the defect data obtained for each of the inspection conditions from the second comparison unit.

9. The inspection apparatus according to claim 8, further comprising a defect classifying conditions setting unit, wherein:
the defect classifying conditions setting unit sets a characteristic quantity of defect obtained for each of the inspection conditions from the characteristic quantity extraction unit as the defect classification condition, the characteristic quantity of defect for each of the inspection conditions having a largest separation degree between bifurcated defect species for each bifurcation to classify the kind of detect by repeating the bifurcation; and
the defect classification processing unit classifies the kind of defects by repeating the bifurcation in accordance with the defect classification conditions set by the defect classifying conditions setting unit.

10. An inspection method comprising the steps of:
irradiating onto a target substrate with illumination light while moving a stage in one direction on which the target substrate with a plurality of dies arrayed thereon is mounted;
acquiring image signals by detecting reflected light obtained from the substrate during the irradiation with the illumination light; and
processing the acquired image signals;
wherein the step of processing the image signals further includes the steps of:
storing the acquired image signals;
obtaining differential image signals by calculating differential between the images signals obtained for each die in the image signals stored by the storing step;
setting a first threshold and a second threshold higher than the first threshold;
comparing the differential image signals independently with each of the set first threshold and second threshold; and
classifying kind of defects based on defect signals obtained in the comparing step by conducting the comparisons between the differential image signal and the first threshold and between the differential image signal and the second threshold.

11. The inspection method according to claim 10, wherein: in the step of classifying the defects, various characteristic quantities of the defect are extracted based on the defect signal obtained by comparing the differential image signal and the first threshold in the comparing step, and the kind of defects are classified based on the extracted various characteristic quantities and the defect signal obtained by comparing the differential image signal and the second threshold.

12. The inspection method according to claim 10, wherein: the step of obtaining the differential image signal further includes the step of aligning in pixel unit or in sub-pixel unit between image signals obtained from each of adjacent dies in the image signals stored in the storing step and the step of obtaining the differential image signal by calculating the differential between the aligned image signals of the each of adjacent dies.

13. The inspection method according to claim 10, wherein, in the step of setting the thresholds, the first and second thresholds are set on basis of the differential image signal obtained by the obtaining step.

14. The inspection method according to claim 10, wherein, in the step of classifying the kind of defects, the kind of defect is classified by repeating bifurcation.

15. The inspection method according to claim 11, wherein the step of processing the image signals further includes the step of setting defect classification conditions beforehand, and wherein, in the step of classifying the kind of defects, the kind of defect is classified on the basis of the extracted various characteristic quantities of defect and the defect signal in accordance with the set defect classification conditions.

16. The inspection method according to claim 15, wherein: the step of setting the defect classification conditions sets the characteristic quantity of defect as the defect classification condition, the characteristic quantity of defect having a largest separation degree between bifurcated defect species for each bifurcation to classify the kind of detect by repeating the bifurcation, the characteristic quantity further including characteristic quantity of defect, obtained when at least an irradiation angle and irradiation luminous quantity of the illumination optical system are modified as inspection conditions.

17. The inspection method according to claim 15, wherein the step of setting the defect classification condition further includes the step of displaying on a screen of a display device an accuracy ratio of defect when the kind of defect is classified in accordance with the set defect classification conditions.
